(19) United States
(12) Patent Application Publication
(10) Pub. No.: US 2017/0069110 A1
(43) Pub. Date: Mar. 9, 2017

(54) SHAPE MEASURING METHOD

(71) Applicant: CANON KABUSHIKI KAISHA, Tokyo (JP)

(72) Inventor: Masaki Nakajima, Utsunomiya-shi (JP)

(21) Appl. No.: 15/245,619

(22) Filed: Aug. 24, 2016

(30) Foreign Application Priority Data
Sep. 8, 2015 (JP) 2015-176411

(51) Int. Cl. G06T 7/60; H04N 5/225; H04N 5/232

(52) U.S. Cl. CPC G06T 7/60; H04N 5/232; H04N 5/2256

(57) ABSTRACT

A measuring method that measures a shape of an object comprises measuring to obtain image data obtained by imaging the object that is irradiated with light and measures an outline shape of the object; determining to determine whether or not the object is present in the outer peripheral portion of the image data (the outer portion) that has been obtained in the measuring; and compositing to change a measurement region, perform the measuring, and obtain composite image data by combining image data that was obtained before a change of the measurement region and image data that was obtained after the change of the measurement region together if, in the determining, the object is determined to be present in the outer portion. The determining is performed for a composite image data, the compositing and the determining are repeated until the object is determined not to be present in the outer portion.

### BACKGROUND OF THE INVENTION

Field of the Invention

The present invention relates to a shape measuring method.

Description of the Related Art

There is a method that measures a shape of an object to be measured based on a result for measuring the object to be measured (image data) that was obtained by using a measuring apparatus having an illumination unit and an imaging unit. If the entire shape of the object to be measured is measured by combining the measuring results of each part of the object to be measured together, obtaining the image data for the entire object to be measured, correctly detecting the outline of the object to be measured from the image data, and combining the pieces of the image data together are required. As a method for detecting the outline, Japanese Patent Application Laid-Open Publication No. 2003-283766 discloses a method that obtains an edge of the image data based on a light intensity distribution of the image data that was obtained by vertical illumination serving as an illumination unit, and recognizes the edge that has been obtained as the outline of the object to be measured. As a method for obtaining the image data of the entire object to be measured, Japanese Patent Application Laid-Open Publication No. 9-189512 discloses a method that moves a measurement position so as to enable obtaining the image data of the entire object to be measured based on measurement conditions (for example, measurement start position and measurement end position) that have been set in advance.

However, in the method disclosed in Japanese Patent Application Laid-Open Publication No. 2003-283766, if there is variation in the height direction of the object to be measured (for example, a step), it is impossible to distinguish whether the edge that has been obtained is either of the boundary of the step or the outline of the object to be measured. Accordingly, depending on the shape of the object to be measured, it is impossible to correctly measure the shape of the object to be measured. In contrast, in the method disclosed in Japanese Patent Application Laid-Open Publication No. 9-189512, there may be a case in which the entire object to be measured cannot be measured in the measurement conditions that have been set in advance. Additionally, the method cannot handle a case in which the measurement condition cannot be set in advance, for example, a case in which the shape of the object to be measured is unclear.

### SUMMARY OF THE INVENTION

The present invention is to provide a measuring method that is, for example, advantageous in measurement precision.

The present invention is a measuring method that measures the shape of an object to be measured, the method comprising: a measurement process that obtains image data obtained by imaging the object to be measured that is irradiated with light and measures the outline shape of the object to be measured; a determination process that determines whether or not the object to be measured is present in the outer peripheral portion of the image data that has been obtained in the measurement process; and a composite process that changes a measurement region, performs the measurement process, and obtains composite image data by combining image data that was obtained before the change of the measurement region and image data that was obtained after the change of the measurement region together if, in the determination process, the object to be measured is determined to be present in the outer peripheral portion of the image data, wherein the determination process is performed for the composite image data, the composite process and the determination process are repeated until the object to be measured is determined not to be present in the outer peripheral portion of the composite image data.

Further features of the present invention will become apparent from the following description of exemplary embodiments with reference to the attached drawings.

### BRIEF DESCRIPTION OF THE DRAWINGS

FIG. 1 illustrates an example of a shape measurement apparatus of a first embodiment.

FIG. 2 is a flowchart illustrating a shape measuring process of the first embodiment.

FIG. 3 illustrates moving directions of a measuring region when the shadow of an object to be measured is not present in measuring data.

FIG. 4A illustrates a case in which the shadow of the object to be measured is present in the outer peripheral portion of the measuring data.

FIG. 4B illustrates a case in which the shadow of the object to be measured is present in the outer peripheral portion of the measuring data.

FIG. 5A illustrates a case in which the shadow of the object to be measured is not present in the outer peripheral portion of the measuring data.

FIG. 5B illustrates a case in which the shadow of the object to be measured is not present in the outer peripheral portion of the measuring data.

FIG. 6 illustrates directions in which the object to be measured extends.

FIG. 7 illustrates a shared region in the measurement region before and after the movement of the measurement region.

FIG. 8A illustrates a light intensity image before a movement of the measurement position.

FIG. 8B illustrates a light intensity image after the movement of the measurement position.

FIG. 8C illustrates a light intensity image combined with light intensity image diagrams before and after the movement of the measurement position.

FIG. 8D illustrates an outer peripheral portion after combining measurement data.

FIG. 9 illustrates an example of the shape measuring apparatus in a second embodiment.

FIG. 10 is a flowchart illustrating a shape measuring process of the second embodiment.

### DESCRIPTION OF THE EMBODIMENTS

### First Embodiment

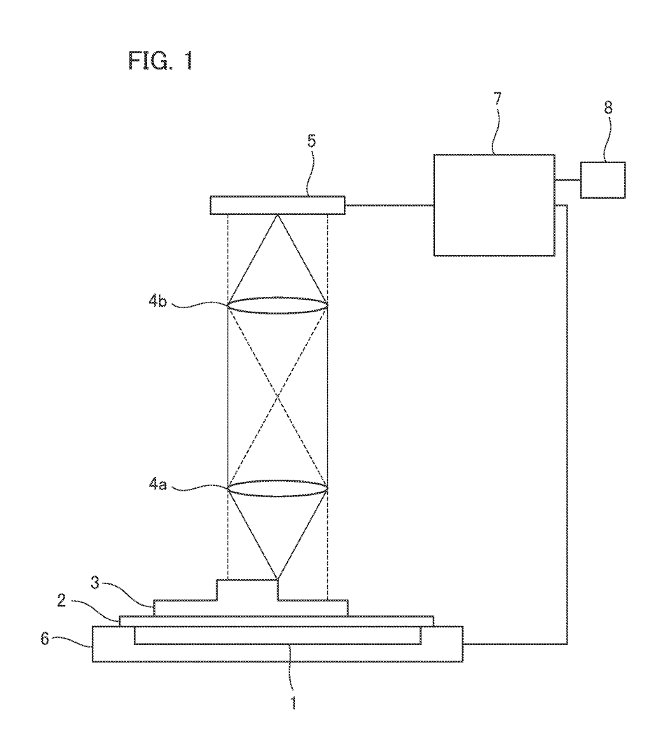

FIG. 1 illustrates an example of a shape measuring apparatus of a first embodiment. A transmitted illumination light source 1 is a coherent light source or an incoherent light source, for example, a laser, an LED, and a lamp. A luminous flux emitted from the transmitted illumination light source 1 is irradiated to an object to be measured 3 that is placed on a transparent mount table 2, which is made of a glass or a diffusion plate. Subsequently, the light flux that has transmitted there through without being blocked by the object to be measured 3 is obtained as an outline image of the object to be measured 3 by a two-dimensional imaging element 5 through an objective lens 4a and an image-forming lens 4b, and the image is stored in a storage unit 8 through a control analysis unit 7. In addition, in the control analysis unit 7, the directions in which the object to be measured 3 is continued are recognized based on the outline image that has been obtained by the two-dimensional imaging element 5. Additionally, the mount table 2 has a mount table drive unit 6, and can move the object to be measured 3 in the directions in which the object to be measured 3, which was recognized in the control analysis unit 7, extends.

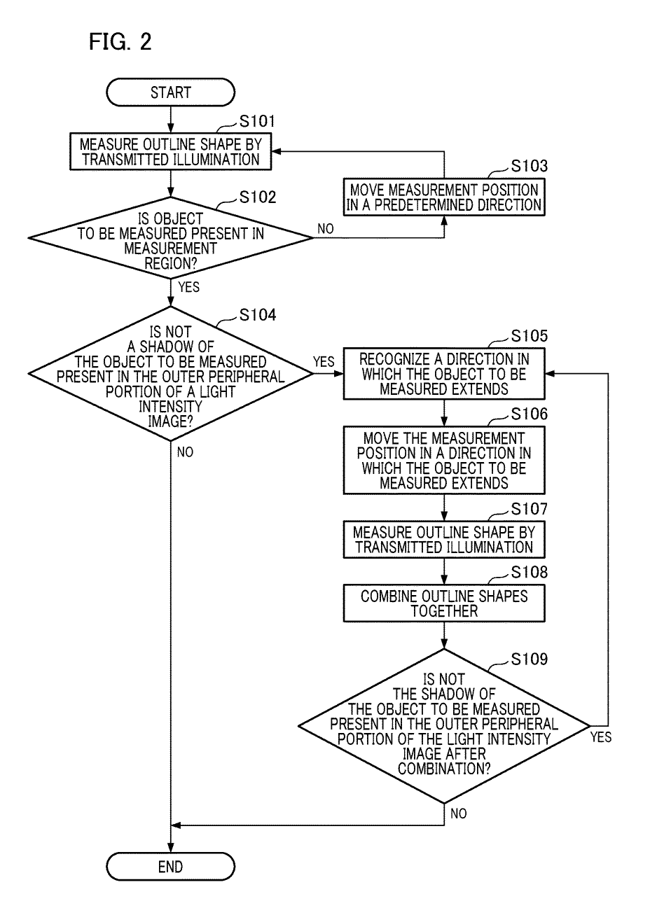

FIG. 2 is a flowchart illustrating a shape measuring process in the first embodiment. In S101, the outline shape of the object to be measured is measured and obtained. The object to be measured 3 is illuminated from the bottom by the transmitted illumination light source 1, the outline shape of the object to be measured 3 is obtained as image data, which is a light intensity image, and the light intensity image is stored in the storage unit 8.

In S102, it is determined whether or not the object to be measured is present in a measurement region. First, it is determined whether or not a pixel for which a value of a light intensity is lower than a threshold value that has been set is present in a light intensity image that represents the outline shape of the object to be measured 3, which was obtained in S101. The threshold value is, for example, a light intensity of the transmitted illumination light source 1, and it can be obtained by performing measurement without positioning the object to be measured 3 and calculating the average value of the light intensity image that has been obtained. Because the measurement is performed by transmitted illumination, in the region where the object to be measured 3 is present, light from the transmitted illumination light source 1 is blocked, and as a result, the region becomes a shadow of the object to be measured 3. Therefore, the value of the pixel corresponding to the region where the object to be measured 3 is present is lower than the threshold value. If the pixel having low light intensity is present in the light intensity image, in other words, if the shadow of the object to be measured 3 is present in the light intensity image, the process proceeds to S104, and if the shadow is not present, the process proceeds to S103.

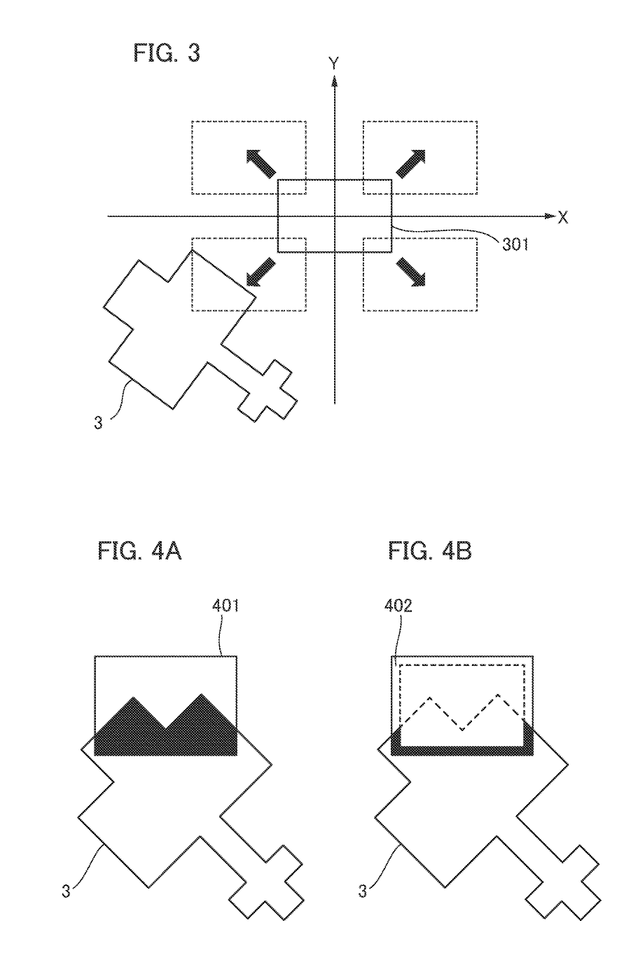

In S102, if the object to be measured 3 is determined to not be present in the measurement region, in S103, the measurement region is moved in a predetermined direction. For example, as shown in FIG. 3, the process returns to S101 by moving a measurement region 301 in any of four directions. At this time, the moving direction may be set in advance, or may be determined randomly in each case. In the first embodiment, although the measurement region is moved by moving the mount table 2 by the mount table drive unit 6, it may be moved by driving a measuring system including the objective lens 4a, the image-forming lens 4b, the two-dimensional imaging element 5, and the like.

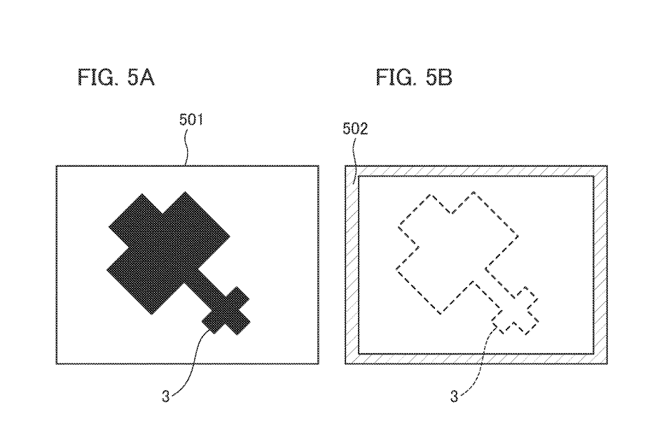

In S102, if the object to be measured 3 was determined to be present in the measurement region, in S104, it is determined whether or not the object to be measured 3 is present outside of the measurement region. That is, among the pixels in the outer peripheral portion of the light intensity image representing the outline shape of the object to be measured 3 that was obtained in S101, in a manner similar to S102, it is determined whether or not a pixel for which the value of the light intensity is lower than the threshold value that has been set is present. The threshold value is similar to that in S102. As shown in FIGS. 4A and 4B, if a pixel for which the value of the light intensity is lower than the threshold value, which is a shadow of the object to be measured 3, is determined to be present in an outer peripheral portion 402 of a light intensity image 401, determining that the object to be measured 3 is present outside of the measurement region in S101 is possible. Thus, if the shadow of the object to be measured 3 is determined to be present in the outer peripheral portion, the object to be measured 3 is present also outside of the measurement region, so that the process proceeds to S105. Additionally, as shown in FIGS. 5A and 5B, if it is determined that the pixel for which the value is lower than the threshold value, which is a shadow of the object to be measured 3, is not present in an outer peripheral portion 502 of a light intensity image 501, it is determined that the entire object to be measured 3 is measured by the measurement in S101, and consequently, the measurement ends.

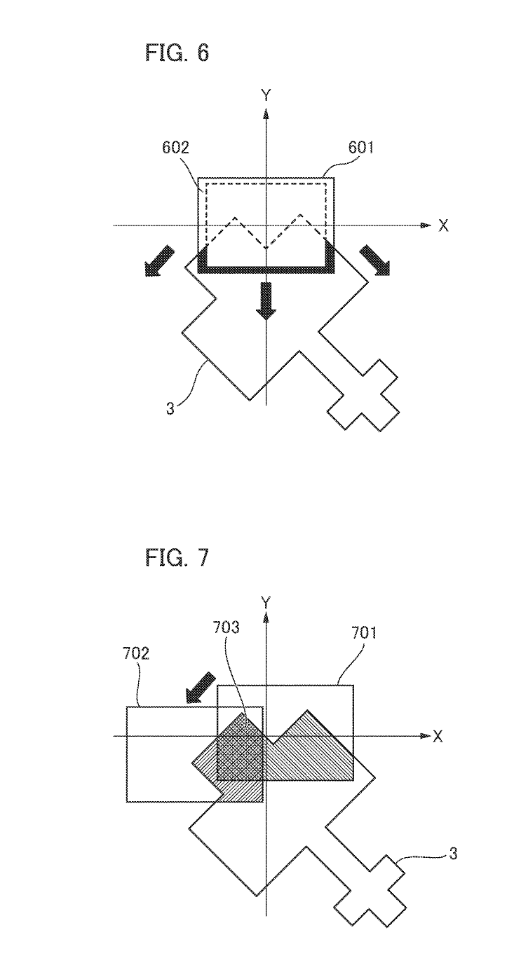

In S104, if the object to be measured is determined to be present outside of the measurement region, in S105, the direction in which the object to be measured extends is recognized. The direction in which the object to be measured 3 extends is recognized based on the position of the pixel for which the value of the light intensity is lower than the threshold in the outer peripheral portion of the light intensity image that was obtained by the control analysis unit 7. As shown in FIG. 6, if the position of the pixel in which the shadow of the object to be measured 3 is present is found in an outer peripheral portion 602 of a measurement region 601, it is possible to recognize the direction in which the object to be measured is continued.

In S106, the measurement region is moved in a direction in which the object to be measured that was recognized in S105 extends. The mount table drive unit 6 drives the mount table 2 in the direction in which the object to be measured 3 that was recognized by the control analysis unit 7 extends, and the measurement region is changed. At this time, the measurement region is desirably moved such that a measurement region 702 after a movement and a measurement region 701 before a movement have a shared region, which is like a grid pattern region 703 in FIG. 7. Additionally, in the first embodiment, although the measurement region is moved by driving the mount table 2, the measurement region may be moved by driving the measuring system including the objective lens 4a, the image-forming lens 4b, the two-dimensional imaging element 5, and the like.

In S107, the outline shape of the object to be measured is measured by transmitted illumination. In S106, in a state in which the measurement region is moved, the object to be measured 3 is illuminated from the bottom by the transmitted illumination light source 1 in a manner similar to S101, the outline shape of the object to be measured 3 is measured as a light intensity image, and the light intensity image is stored in the storage unit 8. Next, in S108, the outline shapes are combined together, and composite image data is generated. In the control analysis unit 7, the light intensity images obtained in S101 and S107 (image data before the change of the measurement region and image data after the change of the measurement region) are combined together, and the measurement region is consequently expanded.

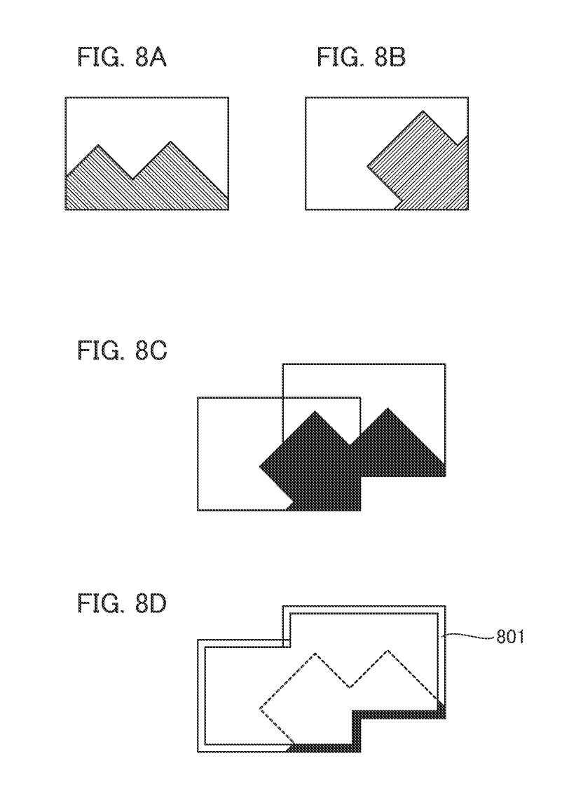

In S109, the control analysis unit 7 determines whether or not the shadow of the object to be measured 3 is present in the outer peripheral portion data of the combined light intensity image. FIG. 8C illustrates a light intensity image that is obtained by combining a light intensity image before a movement (FIG. 8A) and a light intensity image after a movement (FIG. 8B) together. As shown in FIG. 8D, it is determined whether or not the shadow of the object to be measured 3 is present in an outer peripheral portion 801 of the combined light intensity image. If the shadow of the object to be measured 3 is not present, the measurement ends, and if the shadow is present, the flow of S105, S106, S107, S108, through S109 is repeated again, until the shadow of the object to be measured 3 in the outer peripheral portion of the combined light intensity image disappears. If the pixel for which the value of the light intensity is lower than the threshold value, which is the shadow of the object to be measured 3, is determined not to be present in the outer peripheral portion 801 of the combined light intensity image, it is possible to determine that the entire object to be measured 3 is measured, and the measurement can consequently be ended.

As described above, without performing input or alignment of the outer shape of the object to be measured in advance, it is possible to automatically and correctly measure the outer shape of the object to be measured that is viewed from a given direction without erroneous recognition of the outline. Additionally, with respect to the shape of the portion that cannot be measured by transmitted illumination, shape measurement may be performed by using, for example, illumination that illuminates the object to be measured 3 from an oblique direction or using vertical illumination that illuminates it from a direction that is coaxial to the transmitted illumination.

### Second Embodiment

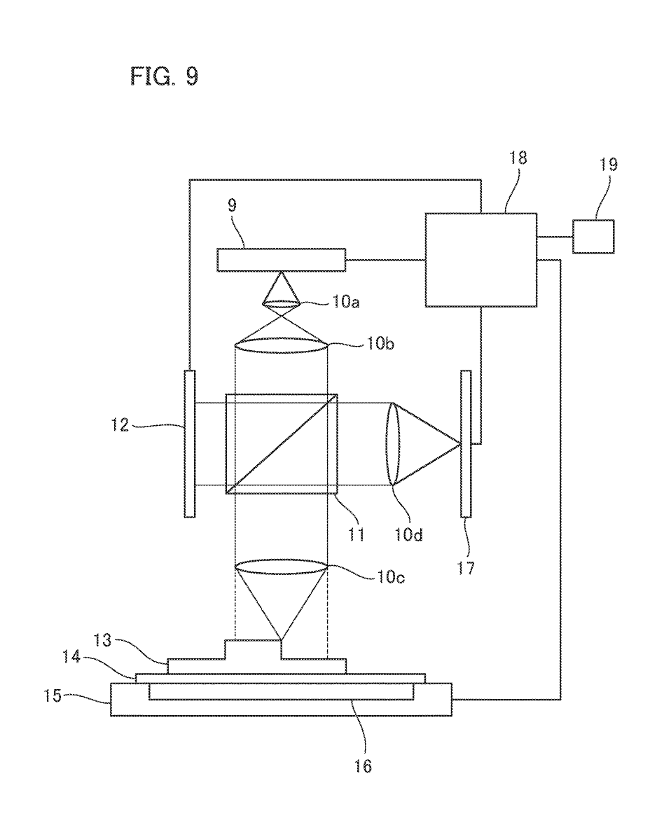

FIG. 9 is a diagram illustrating an example of the shape measuring apparatus of the second embodiment. A light source 9 is a coherent light source, for example, a laser or the like. Regarding a light flux of vertical illumination that is emitted from the light source 9, the light flux is enlarged by a magnifying lens 10a, is made parallel by a collimator lens 10b, and divided into a light flux directing toward a reference surface 12 and a light flux directing toward an object to be measured 13 by a beam splitter 11. First, the light flux directed toward the reference surface 12 is reflected on the reference surface 12 and returns to the beam splitter 11 again as reference light. In contrast, the light flux directed toward the object to be measured 13 is irradiated to the object to be measured 13 that is placed on a transparent mount table 14, which is made of glass or a diffusion plate, through an objective lens 10c. Here, because the mount table 14 moves the object to be measured 13 to the measurement region, it includes a drive unit 15 that drives the mount table 14, and a light source 16 that illuminates the object to be measured 13 by transmitted light. The light source 16 is an incoherent light source, for example, an LED, a lamp, and the like. Subsequently, the light flux is reflected by the object to be measured 13, returns to the beam splitter 11 again through the objective lens 10c as test light, causes interference with the reference light that was reflected from the reference surface 12, passes through an image-forming lens 10d, and an interference pattern is formed on the top of a two-dimensional imaging element 17. While minutely moving the reference surface 12 by a control analysis unit 18, a plurality of interference fringes are obtained, and the shape of the object to be measured 13 is measured based on the plurality of images that has been obtained. The light flux emitted from the light source 16 illuminates the object to be measured 13 from the bottom, is transmitted through the mount table 14, and thereafter, the outline image of the object to be measured 13 is obtained as a light intensity image by the two-dimensional imaging element 17 through the objective lens 10c, the beam splitter 11, and the image-forming lens 10d.

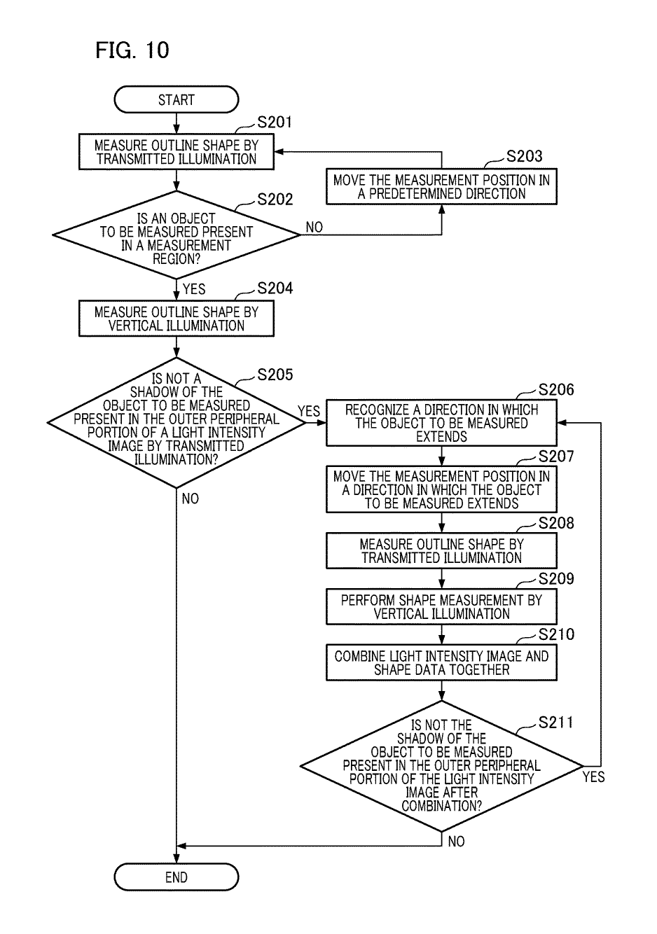

FIG. 10 is a flowchart illustrating a shape measuring process of the second embodiment. First, in S201, the outline shape of the object to be measured is measured. The transmitted illumination light source 16 illuminates the object to be measured 13 from the bottom, the two-dimensional imaging element 17 obtains the outline shape of the object to be measured 13 as image data, which is a light intensity image, and the light intensity image is stored in a storage unit 19 through the control analysis unit 18.

In S202, it is determined whether or not the object to be measured is present in the measurement region. First, it is determined whether or not a pixel for which the value of the light intensity is lower than the threshold value that was set is present in the light intensity image representing the outline shape of the object to be measured 13 that has been obtained in S201. The threshold value is the light intensity of the transmitted illumination light source 16, and can be obtained, for example, by performing measurement without positioning the object to be measured 13 and calculating the average value of the light intensity image that has been obtained. Because the measurement is performed using transmitted illumination, in the region where the object to be measured 13 is present, light from the transmitted illumination light source 16 is blocked, and as a result, the region becomes a shadow of the object to be measured 13. Therefore, the value of the light intensity of the pixel corresponding to the region where the object to be measured 13 is present is lower than the threshold value. When a pixel having low light intensity is present in the light intensity image, that is, when the shadow of the object to be measured 13 is present in the light intensity image, the process proceeds to S204, if the shadow is not present, the process proceeds to S203.

In S202, if the object to be measured 13 is determined not to be present in the measurement region, in S203, the measurement region is moved in a predetermined direction. The process returns to S201, for example, through a process in which the measurement region is moved in any one of four directions in a manner similar to S103 of FIG. 2. At this time, the direction of moving the measurement region may be set in advance, or may be determined randomly in each case. In the second embodiment, although the measurement region is moved by moving the mount table 14 using the mount table drive unit 15, the measurement region may be moved by driving the measuring system, which includes the objective lens 10c, the two-dimensional imaging element 17, and the like.

In S202, when the object to be measured 13 is present in the measurement region, in S204, shape measurement of the object to be measured is performed by vertical illumination. The object to be measured 13 is illuminated by the light source 9, the interference fringes are obtained while moving the reference surface 12, the height of the object to be measured 13 is measured by using a method such as the four-bucket algorithm, and the height and shape are consequently obtained.

In S205, it is determined whether or not the object to be measured is present outside of the measurement region based on the light intensity image. First, in the pixel in the outer peripheral portion of the light intensity image that represents the outline shape of the object to be measured 13 that was obtained in S201, it is determined whether or not a pixel for which a value of a light intensity is lower than a threshold value that has been set is present, in a manner similar to S202. The threshold value is similar to that in S202. When the shadow of the object to be measured 13 is not present in the outer peripheral portion of the light intensity image in a manner similar to S104 of the first embodiment, the entire object to be measured 13 is measured by the measurement in S201, and consequently, the measurement ends. However, if the shadow of the object to be measured 13 is present in the outer peripheral portion, the object to be measured 13 is present also outside of the measurement region, and the process proceeds to S206.

In S205, if the object to be measured 13 is determined to also be present outside of the measurement region, in S206, the direction in which the object to be measured extends is recognized. The direction in which the object to be measured 13 extends is recognized based on the position of the pixel having a value lower than the threshold in the outer peripheral portion of the light intensity image that was obtained in the control analysis unit 18. In a manner similar to S105 of the first embodiment, the direction in which the object to be measured extends can be recognized if the position of the pixel in which the shadow of the object to be measured 13 is present is found.

In S207, the measurement region is moved in the direction in which the object to be measured, which was recognized in S206, extends. The mount table 14 is driven by the mount table drive unit 15 in the direction in which the object to be measured 13, which has been recognized in the control analysis unit 18, is continued, and the measurement region is changed. At this time, the measurement region is desirably moved such that a measurement region 702 after a movement and a measurement region 701 before a movement have a shared region, which is like a grid pattern region 703 in FIG. 7. Additionally, in the second embodiment, although the measurement region is moved by driving the mount table 14, the measurement region may be moved by driving the measuring system, which includes the objective lens 10c, the two-dimensional imaging element 17, and the like.

In S208, the outline shape of the object to be measured is measured by transmitted illumination. The object to be measured 13 is illuminated from the bottom by the light source 16 in a manner similar to S201 in a state in which, in S207, the measurement region is moved, the outline shape of the object to be measured 13 is measured as a light intensity image, and the light intensity image is stored in the storage unit 19. Next, in S209, the shape measurement of the object to be measured is performed by vertical illumination. In a manner similar to S204, the object to be measured 13 is illuminated by the light source 9, the interference fringe is obtained while moving the reference surface 12, the height of the object to be measured 13 is measured by using a method such as the four-bucket algorithm, and the height and shape is obtained.

In S210, the outline shape, which was measured by transmitted illumination and the shape of the object to be measured, which was measured by vertical illumination, are each combined together. The light intensity images obtained in S201 and S208 (image data before the change of the measurement region and image data after the change thereof) are combined together, composite image data is generated, and the outer shape in a wider range is calculated. Additionally, the heights and shapes of the objects to be measured that was obtained in S204 and S209 are combined together, and the height and shape in a wider range is calculated. Next, in S211, the presence or absence of the shadow of the object to be measured 13 in the outer peripheral portion of the combined light intensity image is determined. FIG. 8C illustrates a light intensity image that is obtained by combining the light intensity image before a movement (FIG. 8A), and the light intensity image after a movement (FIG. 8B). As shown in FIG. 8D, it is determined whether or not the shadow of the object to be measured is present in the outer peripheral portion 801 of the combined light intensity image. If the shadow of the object to be measured 13 is not present in the outer peripheral portion of the combined light intensity image, the measurement ends. In contrast, if the shadow is present, the flow of S206, S207, S208, S209, S210 through S211 is repeated again, until the shadow of the object to be measured 3 in the outer peripheral portion of the combined light intensity image disappears, and the entire object to be measured is measured. As described above, according to the second embodiment, it is possible to automatically and correctly measure the shape having the height and shape in addition to the outer shape of the object to be measured viewed from a given direction, without performing input or alignment of the outer shape of the object to be measured in advance and without erroneous recognition of the outline.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-176411 filed Sep. 8, 2015, which is hereby incorporated by reference herein in its entirety.

1. A measuring method that measures a shape of an object to be measured, the method comprising:
a measurement process that obtains image data obtained by imaging the object to be measured that is irradiated with light and measures an outline shape of the object to be measured;
a determination process that determines whether or not the object to be measured is present in an outer peripheral portion of the image data that has been obtained in the measurement process; and
a composite process that changes a measurement region, performs the measurement process, and obtains composite image data by combining image data that was obtained before a change of the measurement region and image data that was obtained after the change of the measurement region together if, in the determination process, the object to be measured is determined to be present in the outer peripheral portion of the image data,
wherein the determination process is performed for a composite image data, the composite process and the determination process are repeated until the object to be measured is determined not to be present in the outer peripheral portion of the composite image data.

2. The measuring method according to claim 1, wherein the light is transmitted light by transmitted illumination, and the image data and the composite image data include a light intensity.

3. The measuring method according to claim 2,
wherein the determination process determines that the object to be measured is present in the outer peripheral portion of the image data or that of the composite image data if a pixel for which a value of a light intensity is lower than a threshold is present in the outer peripheral portion of the image data or that of the composite image data.

4. The measuring method according to claim 1
wherein the measuring method has a determination process that determines whether or not the object to be measured is present in the image data that has been obtained in the measurement process prior to the determination process, and
wherein, in the determination process, if the object to be measured is determined not to be present in the image data, the measurement region is moved in a predetermined direction.

5. The measuring method according to claim 4,
wherein the determination process determines that the object to be measured is present in the image data if a pixel for which a value of a light intensity is lower than a threshold is present in the image data.

6. The measuring method according to claim 3,
wherein the threshold value is a light intensity of the transmitted illumination.

7. The measuring method according to claim 1,
wherein the composite process changes the measurement region in a direction in which the object to be measured extends.

8. The measuring method according to claim 7,
wherein the direction in which the object to be measured extends is a direction in which a pixel having a low light intensity is present in an outer peripheral portion of the image data or that of the composite image data.

9. The measuring method according to claim 7,
wherein the change of the measurement region is performed so as to overlap a part of the image data obtained before the change of the measurement region and a part of the image data obtained after the change of the measurement region.

10. The measuring method according to claim 1, wherein the change of the measurement region is performed by moving at least one of an imaging unit that images the object to be measured and the object to be measured.

11. The measuring method according to claim 1,
wherein the light further includes vertical light by vertical illumination, and the measuring process further obtains the height of the object to be measured based on the image data that was obtained by imaging the object to be measured irradiated with the vertical light, and
wherein, in the composite process, if the image data that was obtained before the change of the measurement region and the image data that was obtained after the change of the measurement region are combined together, the heights thereof are also combined together.
